(19) United States
(12) Patent Application Publication
(10) Pub. No.: US 2002/0092397 A1
(43) Pub. Date: Jul. 18, 2002

(54) Auxiliary workpiece-supporting frame assembly for a table saw

(76) Inventor: Tony Liu, Taichung (TW)

Correspondence Address: PILLSBURY WINTHROP, LLP, P.O. BOX 10500, MCLEAN, VA, 22102, US

(21) Appl. No.: 09/760,824

(22) Filed: Jan. 17, 2001

(51) Int. Cl. B27B 5/22

(52) U.S. Cl. 83/471; 83/477.2

(57) ABSTRACT

A table saw includes two rail-supporting seats fixed on opposite side surfaces of a worktable. Each of the seats has front and rear limiting elements and a horizontal row of rollers. Two parallel sliding rails define two dovetail grooves to receive the rollers of the seats slidably to permit horizontal sliding movement of the sliding rails relative to the worktable while preventing transverse removal of the sliding rails from the seats. Each of the sliding rails is provided with front and rear stop elements that are in line with the limiting elements of the seats to limit movement of the sliding rails relative to the worktable between front and rear limit positions, thereby preventing axial removal of the sliding rails from the seats. A supporting rail has two ends connected fixedly to front ends of the sliding rails so that assembly of the supporting rail and the sliding rails is generally U-shaped.

### BACKGROUND OF THE INVENTION

1. Field of the Invention

The invention relates to a table saw, more particularly to a table saw that is provided with an auxiliary workpiece-supporting frame assembly.

2. Description of the Related Art

Referring to FIG. 1, a conventional table saw 1 is shown to include a worktable 2 provided with a cutting blade 3 and two units of workpiece-supporting frame assemblies 10 which are mounted respectively on front and left sides of the worktable 2 so as to support a workpiece (not shown) to be cut by the cutting blade 3.

As illustrated, each workpiece-supporting frame assembly 10 includes two rod-supporting seats 11 fixed to a side of the worktable 2, two cylindrical sliding rods 12 that have proximate inner portions inserted slidably into two sliding holes 111 in the rod-supporting seats 11 and distal outer portions, and a transverse supporting rail 13 which has two opposite ends fixed to the outer portions of the sliding rods 12 by means of nuts 14.

Some drawbacks that result from the use of the conventional table saw are as follows:

(i) Because a relatively large friction occurs between the sliding rods 12 and the seat 11, it is difficult to move the sliding rods 12 relative to the seats 11.

(ii) When the workpiece-supporting frame assembly 10 is in use, the sliding rods 12 are extended outwardly from the worktable 2. Thus, waste resulting from operation of the cutting blade 3 falls over the sliding rods 12, which consequently retards smooth movement of the sliding rods 12 relative to the rod-supporting seat 11.

(iii) The outer portions of the sliding rods 12 bend downward after long term use of the conventional workpiece-suporting frame assembly 10. Thus, the top surface of the supporting rail 13 cannot be disposed at an elevation that is flush with the worktable 2, which consequently degrades the supporting ability of the supporting rail 13.

### SUMMARY OF THE INVENTION

The main object of the present invention is to provide a table saw with a workpiece-supporting frame assembly having two sliding rails which can be moved easily and smoothly relative to a worktable. The second object of the present invention is to provide a table saw with a workpiece-supporting frame assembly having a supporting rail, a vertical position of which relative to the sliding rails can be adjusted so as to dispose an upper surface of the supporting rail flush with that of the worktable, and so as to enhance the stability of a workpiece that is disposed over the supporting frame assembly.

Accordingly, a table saw of the present invention includes a worktable and an auxiliary workpiece-supporting frame assembly. The worktable has a top surface that is adapted to support a workpiece to be cut, and two opposite side surfaces. Each of the side surfaces of the worktable has a front portion and a rear portion. The workpiece-supporting frame assembly includes two elongated rail-supporting seats, two parallel sliding rails, and a supporting rail. The rail-supporting seats are disposed respectively and fixedly on the front portions of the side surfaces of the worktable. Each of the seats has a front portion with a fixed front limiting element, and a rear portion with a fixed rear limiting element, and includes a horizontal row of rollers that are mounted rotatably thereon. Each of the parallel sliding rails is formed with a dovetail groove, within which a respective one of the rows of the rollers is received slidably, thereby permitting horizontal sliding movement of the sliding rails relative to the worktable while preventing transverse removal of the sliding rails from the seats. The front and rear portions of each of the sliding rails are provided respectively with a pair of fixed front and rear stop elements that are in line with the limiting elements of the seats The front and rear limiting elements of each of the seats are located between the front and rear stop elements of a respective one of the sliding rails so as to limit movement of each of the sliding rails relative to the worktable between a front limit position and a rear limit position, thereby preventing axial removal of the sliding rails from the seats. The supporting rail has a top surface that is generally flush with the top surface of the worktable, and two ends that are connected respectively and fixedly to front ends of the sliding rails so that assembly of the supporting rail and the sliding rails is generally U-shaped.

Since the rollers of the seats are rotatably concealed within the dovetail grooves of the sliding rails, waste resulting from the operation of the table saw cannot fall on the rollers. Accordingly, sliding movement of the sliding rails relative to the worktable is not affected by the resulting waste.

In addition, the supporting rail is mounted on the sliding rails in such a manner that the vertical position of the supporting rail relative to the sliding rails can be adjusted. As such, the upper surface of the supporting rail can be kept flush with that of the wortable.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a perspective view of a conventional table saw which is provided with two auxiliary workpiece-supporting frame assemblies;

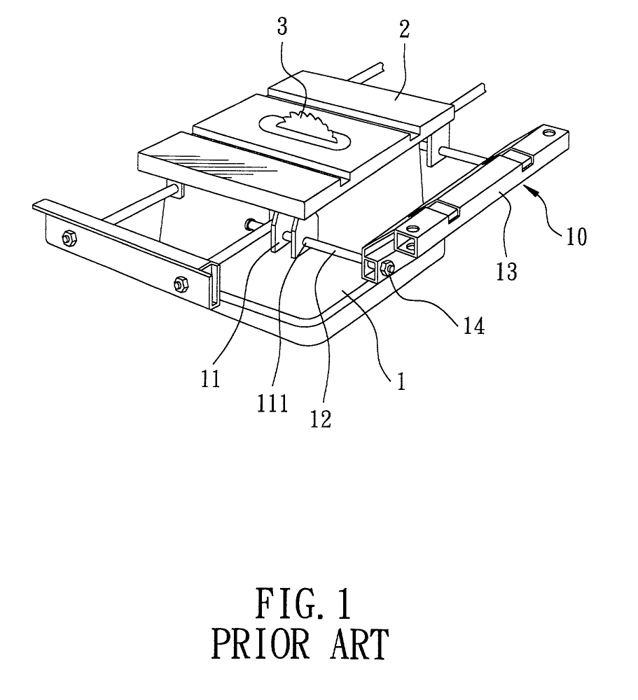

FIG. 2 is a perspective view of the preferred embodiment of a table saw of the present invention which is provided with two auxiliary workpiece-supporting frame assemblies;

FIG. 3 is a partly exploded perspective view of the preferred embodiment, illustrating how the auxiliary workpiece-supporting frame assembly is mounted on a worktable according to the present invention;

FIG. 4 is a partly exploded bottom perspective view of the preferred embodiment, illustrating how the auxiliary workpiece-supporting frame assembly is mounted on the worktable according to the present invention;

FIG. 5 is a fragmentary sectional view of the preferred embodiment, illustrating how a sliding rail is retained securely relative to the worktable;

FIG. 6 is a fragmentary sectional view of the preferred embodiment, illustrating how a supporting rail is mounted on the sliding rails;

FIG. 7 is a front view of the supporting rail of the preferred embodiment, illustrating how a vertical position of the supporting rail is adjusted relative to the sliding rails;

FIG. 8 is a fragmentary partly sectional view of the preferred embodiment, illustrating how the supporting rail is retracted relative to the worktable after release of a lock bolt from the sliding rail; and

FIG. 9 is a fragmentary partly sectional view of the preferred embodiment, illustrating how the supporting rail is extended relative to the worktable after release of the lock bolt from the sliding rail.

### DETAILED DESCRIPTION OF THE PREFERRED EMBODIMENT

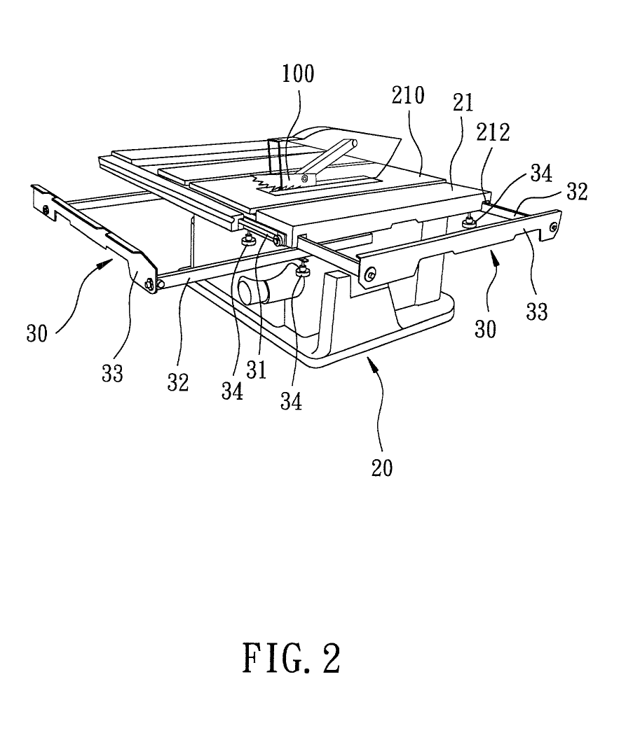

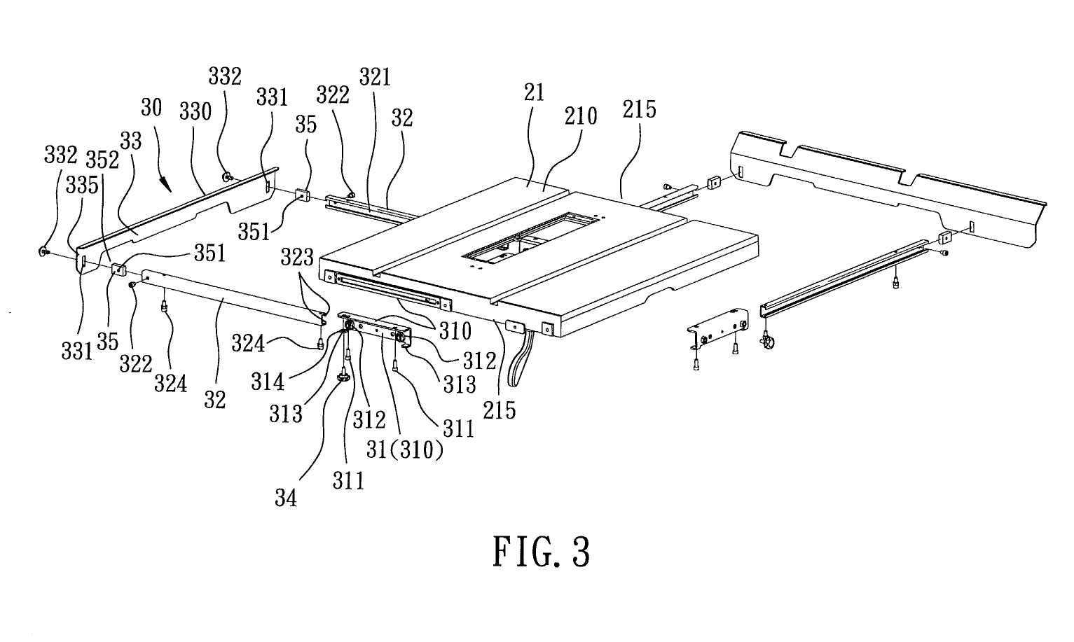

Referring to FIGS. 2, 3 and 4, the preferred embodiment of a table saw according to this invention is shown to include a worktable 21 and two auxiliary workpiece-supporting frame assemblies 30 mounted respectively on front and left portions of the worktable 21, as best shown in FIG. 2. However, for better understanding of the present invention, only one auxiliary workpiece-supporting frame assembly 30 will be explained in the succeeding paragraphs.

As illustrated, the worktable 21 has a top surface 210 that is adapted to support a workpiece (not shown) to be cut, and two opposite side surfaces 215, each of which has a front portion and a rear portion.

Each of the workpiece-supporting frame assemblies 30 includes two elongated rail-supporting seats 31, two parallel sliding rails 32 and a supporting rail 33. A cutting saw 100 is mounted rotatably on the worktable 21 in such a manner that the workpiece supported by assistance of the workpiece-supporting frame assembly 30 can be cut by the cutting saw 100. Since mounting of the cutting saw 100 on the worktable 21 is not pertinent to the present invention, a detailed description of the same is omitted herein for the sake of brevity.

The rail-supporting seats 31 are disposed respectively and fixedly on the front portions of the side surfaces 215 of the worktable 21. Each of the seats 31 has a front portion with a fixed front limiting element 313, and a rear portion with a fixed rear limiting element 313, and a horizontal row of rollers 312 that are mounted rotatably thereon. Two rollers 312 constitute the horizontal row of rollers in this preferred embodiment.

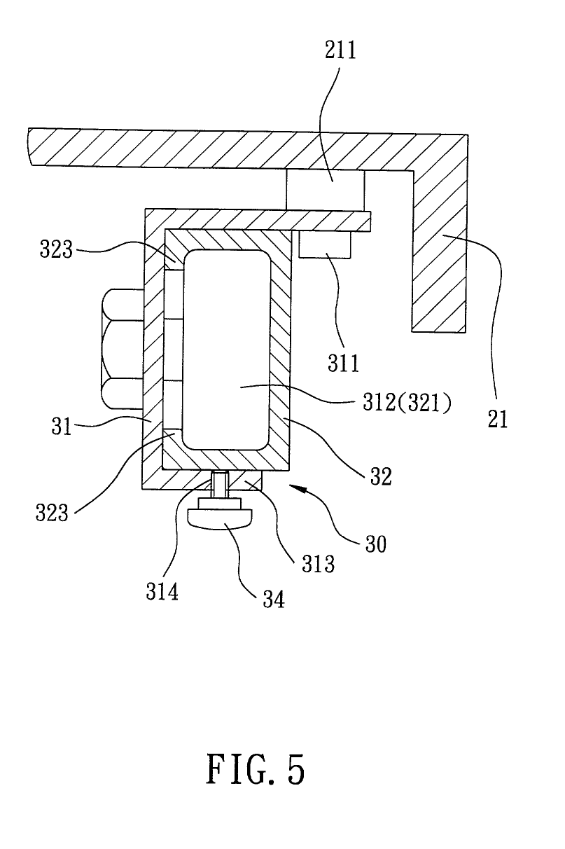

Each of the sliding rails 32 is formed with two vertically extending flanges 323 which define a dovetail groove 321 (see FIG. 5), within which a respective one of the rows of the rollers 312 is received slidably, so as to permit horizontal sliding movement of the sliding rails 32 relative to the worktable 21 while preventing transverse removal of the sliding rails 32 from the seats 31. The front and rear portions of each of the sliding rails 32 are provided respectively with a pair of fixed front and rear stop elements 324 that are in line with the limiting elements 313 of the seats 31. The front and rear limiting elements 313 of each of the seats 31 are located between the stop elements 324 of a respective one of the sliding rails 32 so as to limit movement of each of the sliding rails 32 relative to the worktable 21 between a front limit position, where the front stop elements 324 contact the front limiting elements 313 so as to prevent further rearward movement of the sliding rails 32 relative to the worktable 21, and a rear limit position, where the rear stop elements 313 contact the rear limiting elements 324 so as to prevent further forward movement of the sliding rails 32 relative to the worktable 21, thereby preventing axial removal of the sliding rails 32 from the seats 31. The supporting rail 33 has a top surface 330 that is generally flush with the top surface 210 of the worktable 21, and two ends 335 that are connected respectively and fixedly to front ends of the sliding rails 32 so that assembly of the supporting rail 33 and the sliding rails 32 is generally U-shaped.

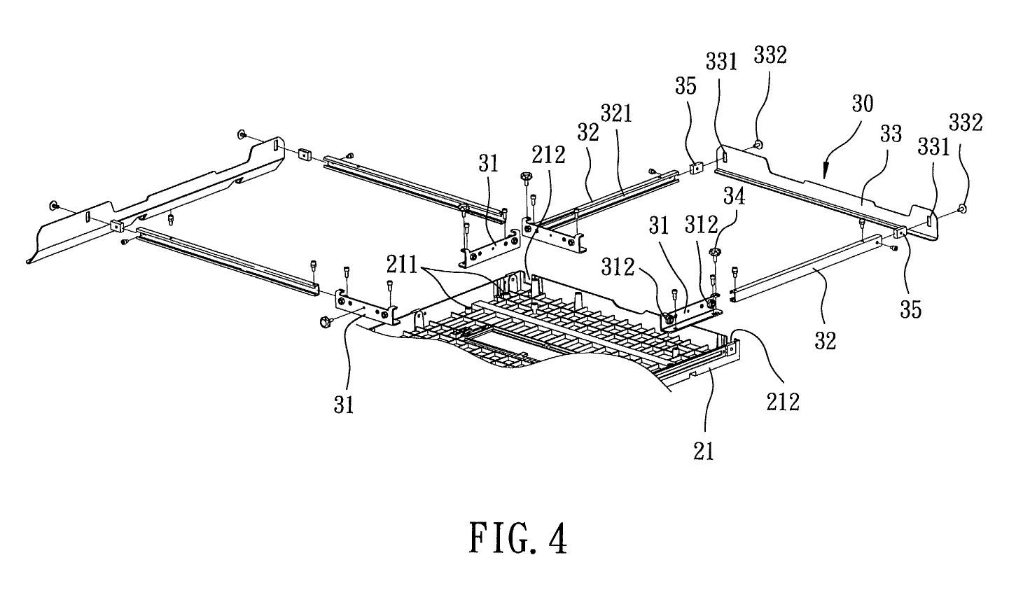

Each of the seats 31 is shaped as a plate, and has a generally inverted L-shaped cross-section, a vertical plate portion 310, and a horizontal plate portion 310′ which extends integrally from an upper end of the vertical plate portion 310 and through which two fastener screws 311 extend to engage two screw-engaging seats 211 (see FIG. 4) of the worktable 21, thereby fixing the seats 31 inboard to the opposite side surfaces 215 of the worktable 21, respectively. In order to complement the mounting position of the seats 31 inboard to the opposite side surfaces 215 of the worktable 21, the front and rear portions of the worktable 21 are formed with two notches 212 (see FIG. 4) to facilitate movement of the sliding rails 32 on the seats 31. The rollers 312 are disposed under the horizontal plate portions 310′ of the seats 31. Each of the front limiting elements 313 is shaped as a projection that extends integrally from a lower end of the vertical plate portion 310′ of a respective one of the seats 31 and that is located at a front end of the respective one of the seats 31 under the horizontal plate portion 310′ of the respective one of the seats 31. Each of the rear limiting elements 313 is shaped as a projection that extends integrally from the lower end of the vertical plate portion 310′ of a respective one of the seats 31 and that is located at a rear end of the respective one of the seats 31 under the horizontal plate portion 310′ of the respective one of the seats 31. The rollers 312 of each of the seats 31 are located between the horizontal plate portion 310′ and the limiting elements 313 of a corresponding one of the seats 31. Each of the stop elements 324 is formed as a vertical stop screw.

Each of the front limiting elements 313 in the seats 31 is formed with a threaded hole 314 therethrough. A vertical lock bolt 34 extends threadably through the threaded hole 314 in a respective one of the front limiting elements 313, and presses against a respective one of the sliding rails 32, thereby locking the sliding rails 32 within the rail-supporting seats 31, as best shown in FIG. 5.

The supporting rail 33 is formed with two vertical slide slots 331 at two end portions 335 thereof.

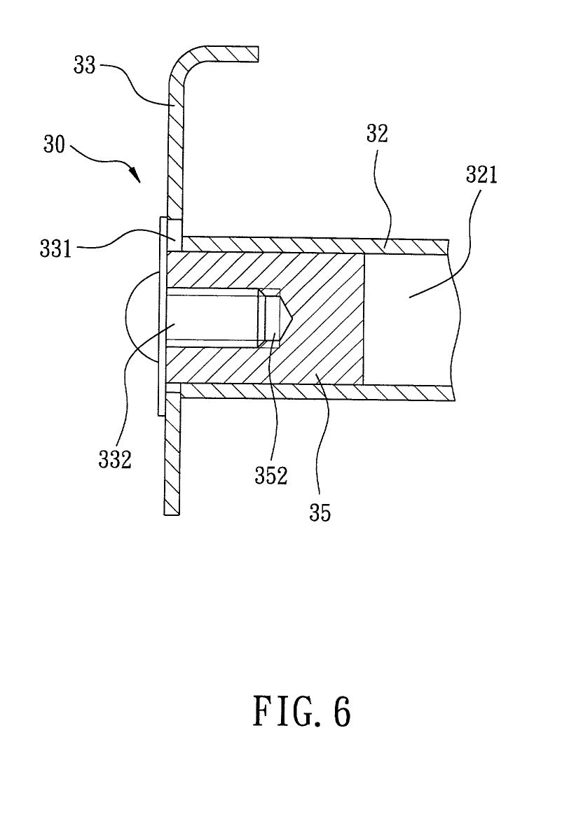

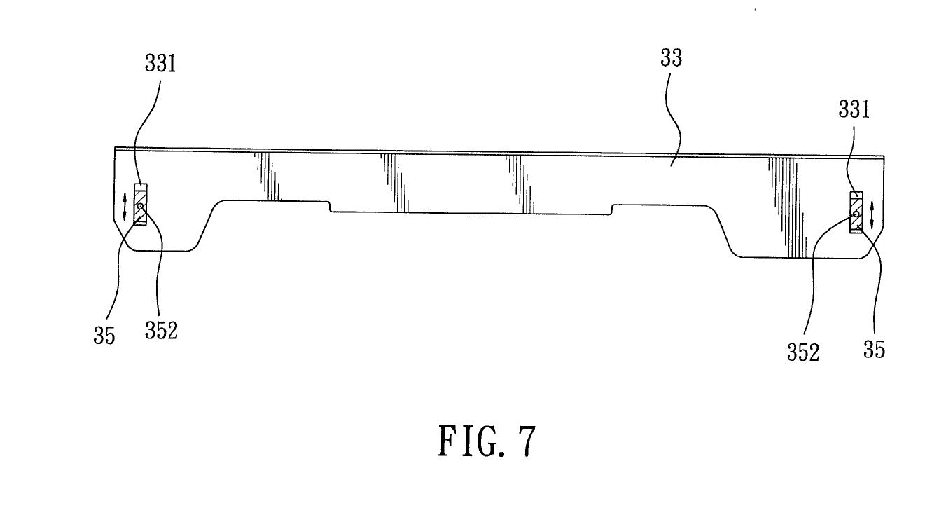

For installing the supporting rail 33 on the sliding rails 32, two rectangular connecting elements 35 are disposed respectively within the dovetail grooves 321 of the sliding rails 32 at the front ends thereof. Two horizontal set screws 322 are inserted to extend through the front ends of the sliding rails 32 and engage respectively two threaded holes 351 in the connecting elements 35 for fixing the latter within the dovetail grooves 321. Then, two horizontal lock bolts 332 are inserted through the slide slots 331 in the supporting rail 33 to engage respectively two threaded holes 352 in the connecting elements 35 for locking the supporting rail 33 on the sliding rails 32. As best shown in FIGS. 6 and 7, since the lock bolt 332 is movable in the slide slots 331 of the supporting rail 33, the vertical position of the supporting rail 33 relative to the sliding rails 32 can be adjusted.

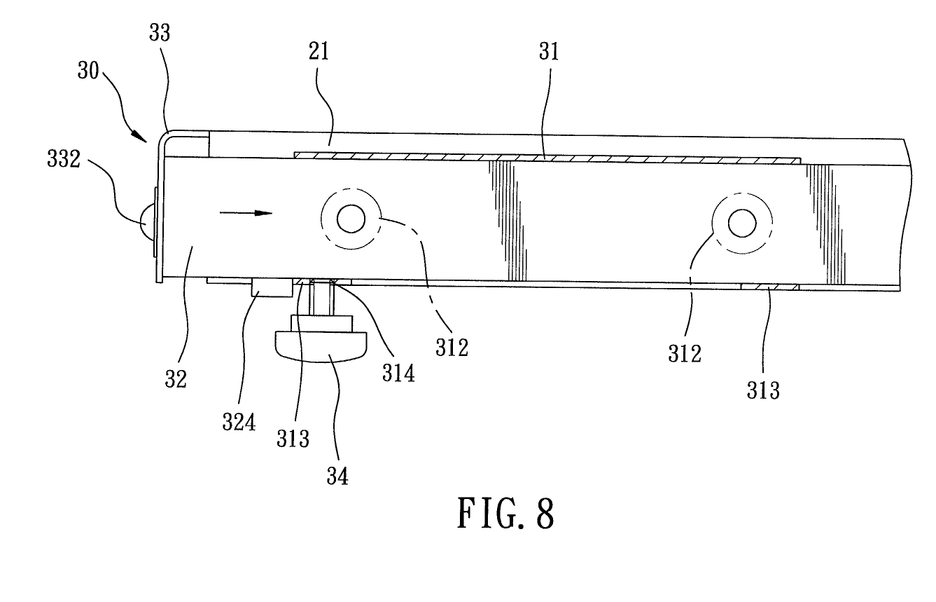

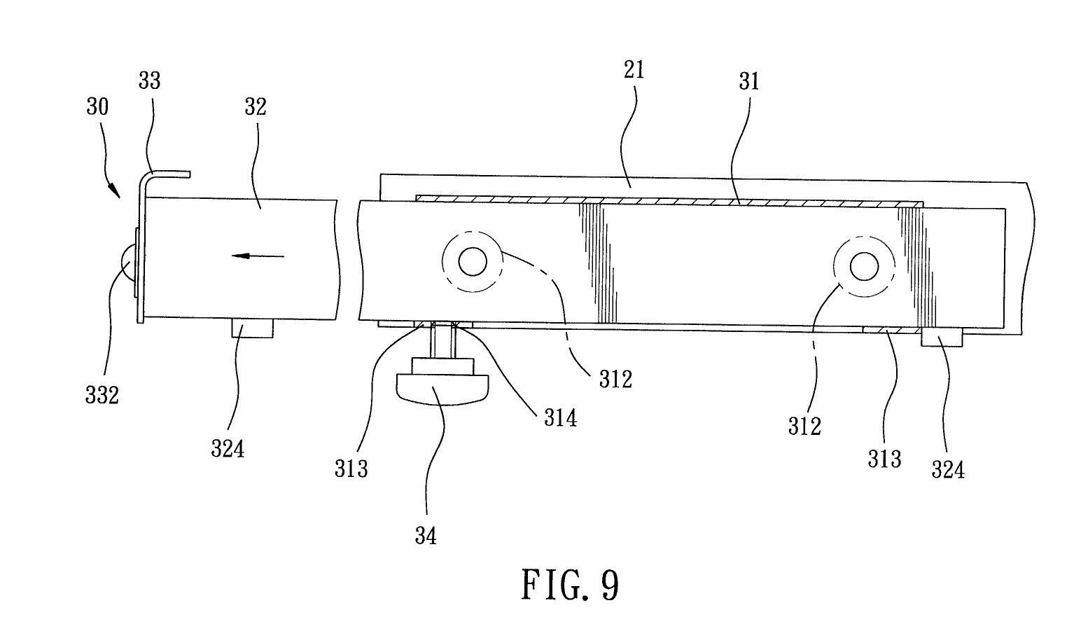

When the auxiliary workpiece-supporting frame assembly 30 is not in use, the sliding rails 32 can be retracted to the rear limit position shown in FIG. 8 relative to the worktable 21 after loosening the lock bolt 34 relative to the seat 31, so as to dispose the supporting rail 33 adjacent to the worktable 21. In case, the operator of the table saw requires the auxiliary workpiece-supporting frame assembly 30 in order to support the workpiece (not shown), he can pull the supporting rail 33 outwardly from the seat 31 so as to dispose the supporting rail 33 at the extended position of FIG. 9, i.e. the front limit position. The lock bolts 34 can be tightened relative to the seats 21 in order to immobilize the frame assembly 30 at the retracted or extended positions.

Since the rollers 312 are concealed and covered rotatably within the dovetail grooves 321 of the sliding rails 32, waste that results from operation of the table saw is prevented from entering into the dovetail grooves 321 in the sliding rails 32. Thus, the horizontal movement of the sliding rails 32 on the seats 31 is not retarded.

In addition, the supporting rail 33 is mounted to the sliding rails 32 in such a manner that the vertical position of the supporting rail 33 relative to the sliding rail 32 can be adjusted. As such, the upper surface of the supporting rail 32 can be kept flush with that of the wortable 21.

With this invention thus explained, it is apparent that numerous modifications and variations can be made without departing from the scope and spirit of this invention. It is therefore intended that this invention be limited only as indicated in the appended claims.

I claim:

1. A table saw comprising:
a worktable having a top surface that is adapted to support a workpiece to be cut, and two opposite side surfaces, each of which has a front portion and a rear portion;
two elongated rail-supporting seats disposed respectively and fixedly on said front portions of said side surfaces of said worktable, each of said seats having a front portion with a fixed front limiting element, and a rear portion with a fixed rear limiting element, and including a horizontal row of rollers that are mounted rotatably thereon;
two parallel sliding rails, each of which is formed with a dovetail groove, within which a respective one of said rows of said rollers is received slidably, thereby permitting horizontal sliding movement of said sliding rails relative to said worktable while preventing transverse removal of said sliding rails from said seats, said front and rear portions of each of said sliding rails being provided respectively with a pair of fixed front and rear stop elements that are in line with said limiting elements of said seats, said front and rear limiting elements of each of said seats being located between said stop elements of a respective one of said sliding rails so as to limit movement of each of said sliding rails relative to said worktable between a front limit position, where said front stop elements contact said front limiting elements so as to prevent further rearward movement of said sliding rails relative to said worktable, and a rear limit position, where rear stop elements contact said rear limiting elements so as to prevent further forward movement of said sliding rails relative to said worktable, thereby preventing axial removal of said sliding rails from said seats; and
a supporting rail having a top surface that is generally flush with said top surface of said worktable, and two ends that are connected respectively and fixedly to front ends of said sliding rails so that assembly of said supporting rail and said sliding rails is generally U-shaped.

2. The table saw as defined in claim 1, wherein each of said seats is shaped as a plate which has a generally inverted L-shaped cross-section, a vertical plate portion, and a horizontal plate portion that extends integrally from an upper end of said vertical plate portion and that is bolted to said worktable, said rollers being disposed under said horizontal plate portions of said seats.

3. The table saw as defined in claim 2, wherein each of said front limiting elements is shaped as a projection that extends integrally, horizontally and outwardly from a lower end of said vertical plate portion of a respective one of said seats and that is located at a front end of the respective one of said seats under said horizontal plate portion of the respective one of said seats, each of said rear limiting elements being shaped as a projection that extends integrally, horizontally and outwardly from said lower end of said vertical plate portion of a respective one of said seats and that is located at a rear end of the respective one of said seats under said horizontal plate portion of the respective one of said seats, said rollers of each of said seats being located between said horizontal plate portion and said limiting elements of a corresponding one of said seats, each of said stop elements being formed as a vertical stop screw.

4. The table saw as defined in claim 3, wherein each of said front limiting elements is formed with a threaded hole therethrough, and includes a vertical lock bolt, which extends threadably through said threaded hole in a respective one of said front limiting elements and which presses against a respective one of said sliding rails, thereby locking said sliding rails within said seats.

5. The table saw as defined in claim 1, wherein said supporting rail is formed with two vertical slide slots at two end portions thereof, said table saw further including:
two connecting elements disposed respectively within said dovetail grooves at said front ends of said sliding rails;
two horizontal set screws extending through said front ends of said sliding rails and said connecting elements for fixing said connecting elements within said dovetail grooves; and
two horizontal lock bolts extending through said slide slots in said supporting rail to engage respectively said connecting elements for locking said supporting rail on said sliding rails;
whereby, vertical position of said supporting rail relative to said sliding rails can be adjusted.
